(19) United States
(12) Patent Application Publication
(10) Pub. No.: US 2021/0224387 A1
(43) Pub. Date: Jul. 22, 2021

(54) INFORMATION PROCESSING APPARATUS AND METHOD OF UPDATING UPDATE PROGRAM

(71) Applicant: CANON KABUSHIKI KAISHA, Tokyo (JP)

(72) Inventor: Takeshi Uragaki, Ibaraki (JP)

(21) Appl. No.: 17/145,022

(22) Filed: Jan. 8, 2021

(30) Foreign Application Priority Data
Jan. 20, 2020 (JP) 2020-006858

(51) Int. Cl. G06F 21/55; G06F 21/51; G06F 8/65; H04N 1/00

(52) U.S. Cl. CPC G06F 21/554; G06F 21/51; G06F 8/65; H04N 1/0097; H04N 2201/0094; H04N 1/00408; H04N 1/00074; G06F 2221/033; H04N 1/00037

(57) ABSTRACT

An information processing apparatus includes at least one memory, the at least one memory storing one or more programs, a processor configured to execute a program in a first activation mode and execute an update program for updating at least a part of the program executed in the first activation mode in a second activation mode, a storage configured to store backup data of the update program, and a tampering detection program stored in the at least one memory and configured to detect tampering with the update program. The update program for which tampering is detected by the tampering detection program is updated using the backup data stored in the storage.

### BACKGROUND

### Field of the Disclosure

The present disclosure relates to an information processing apparatus, and a processing method of an information processing apparatus.

### Description of the Related Art

Tampering with software using software vulnerability to exploit a computer has been an issue. As measures against such an attack, there is known a method of detecting the presence of tampering by storing a signature in a program and verifying the signature of the program each time the program is activated.

There are also known a method of modulizing a program to enable partial replacement of the program, preforming processing for verifying a signature for each module and storing key information for verifying the signature, and a method of verifying whether a correct answer value of each program matches a predetermined value when the program is activated (Japanese Patent Application Laid-Open No. 2019-75000).

To update a program, there is a case where a plurality of activation modes is prepared and changed depending on the intended use. In this case, tampering can occur in each of the activation modes. Thus, a method of detecting tampering in each of the activation modes is used (Japanese Patent Application Laid-Open No. 2015-97022).

In a case where tampering is detected at the time of activation, the operation of each program is stopped to prevent a malicious operation. A notification, such as an error code, is displayed on an operation unit to notify a user that the tampering has occurred.

In this case, however, the program does not operate, and therefore, it may be desirable for the user to call a service-person because the user is unlikely to know how to carry out restoration. However, this involves not only physical cost, but also frequent downtime in which a device is unavailable.

It is also possible to provide a plurality of activation programs and perform restoration by executing update using an activation program not tampered with among the activation programs. However, in a case where tampering is detected in each of the activation programs, there may be no way of performing restoration.

### SUMMARY

Embodiments of the present disclosure are directed to enabling a software module to be updated in a case where the software module is determined to be tampered with.

According to embodiments of the present disclosure, an information processing apparatus includes at least one memory, the at least one memory storing one or more programs, a processor configured to execute a program in a first activation mode and execute an update program for updating at least a part of the program executed in the first activation mode in a second activation mode, a storage configured to store backup data of the update program, and a tampering detection program stored in the at least one memory and configured to detect tampering with the update program. The update program for which tampering is detected by the tampering detection program is updated using the backup data stored in the storage.

Further features of the present disclosure will become apparent from the following description of exemplary embodiments with reference to the attached drawings.

### BRIEF DESCRIPTION OF THE DRAWINGS

FIG. 1 is a hardware configuration example of a multifunctional peripheral.

FIG. 2 is a functional configuration example of the multifunctional peripheral.

FIGS. 3A to 3D illustrate operation at the time of activation.

FIG. 4 is a flowchart illustrating a processing method of the multifunctional peripheral.

FIG. 5 is a flowchart illustrating a processing method of the multifunctional peripheral.

FIG. 6 is a flowchart illustrating a processing method of the multifunctional peripheral.

### DESCRIPTION OF THE EMBODIMENTS

A first exemplary embodiment will be described below with reference to the drawings. The following exemplary embodiments are not intended to limit the present disclosure according to the scope of the present disclosure, and not all of combinations of features described in the exemplary embodiments are necessarily required for a solution of the present disclosure. A multifunctional peripheral (a digital multi-function peripheral or MFP) will be described as an example of an information processing apparatus according to the exemplary embodiments. However, the information processing apparatus is not limited to the multifunctional peripheral.

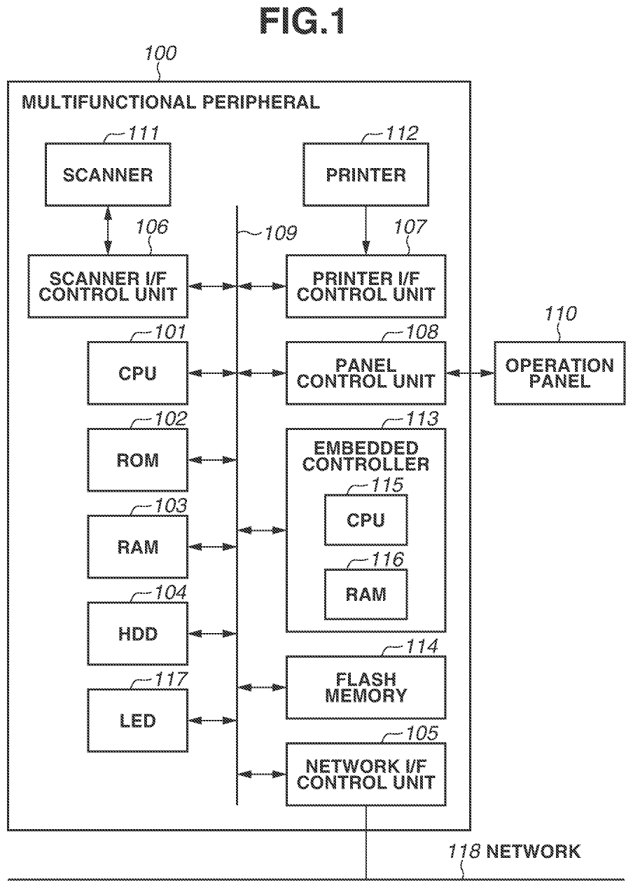

FIG. 1 illustrates an example of a hardware configuration of a multifunctional peripheral 100 according to the first exemplary embodiment. The multifunctional peripheral 100 is an example of the information processing apparatus. The multifunctional peripheral 100 includes a central processing unit (CPU) 101, a read-only memory (ROM) 102, a random access memory (RAM) 103, and a hard disk drive (HDD) 104. The multifunctional peripheral 100 further includes a network interface (I/F) control unit 105, a scanner I/F control unit 106, a printer I/F control unit 107, a panel control unit 108, a scanner 111, a printer 112, an embedded controller 113, a flash memory 114, and a light emitting diode (LED) 117. The embedded controller 113 includes a CPU 115 and a RAM 116.

The CPU 101 executes a software module (a program) of the multifunctional peripheral 100, and controls the entire multifunctional peripheral 100. The ROM 102 stores a Basic Input/Output System (BIOS) of the multifunctional peripheral 100 and data, such as fixed parameters. The RAM 103 stores, for example, a program, and temporary data when the CPU 101 controls the multifunctional peripheral 100. The HDD 104 stores some of applications and various data. The flash memory 114 stores various modules, such as a loader, a kernel, and an application.

The CPU 115 of the embedded controller 113 executes a software module of the embedded controller 113, and performs a part of control of the multifunctional peripheral 100. The RAM 116 stores, for example, a program, and temporary data when the CPU 115 controls the multifunctional peripheral 100. The multifunctional peripheral 100 includes a main controller that performs overall control, in contrast to the embedded controller 113. The main controller includes at least the CPU 101, the ROM 102, and the RAM 103.

The network I/F control unit 105 controls transmission and reception of data to and from a network 118. The scanner I/F control unit 106 controls reading of an original document performed by the scanner 111. The printer I/F control unit 107 controls processing, such as print processing, performed by the printer 112. The panel control unit 108 controls a touchscreen-type operation panel 110 and controls display of various kinds of information and instruction inputs from a user.

A bus 109 interconnects the CPU 101, the ROM 102, the RAM 103, the HDD 104, the network I/F control unit 105, the scanner I/F control unit 106, and the printer I/F control unit 107. The bus 109 also interconnects the panel control unit 108, the embedded controller 113, and the flash memory 114. Control signals of the CPU 101 and data of each component are transmitted and received via the bus 109. The LED 117 is turned on as appropriate, and is used to notify the outside of abnormalities of software or hardware.

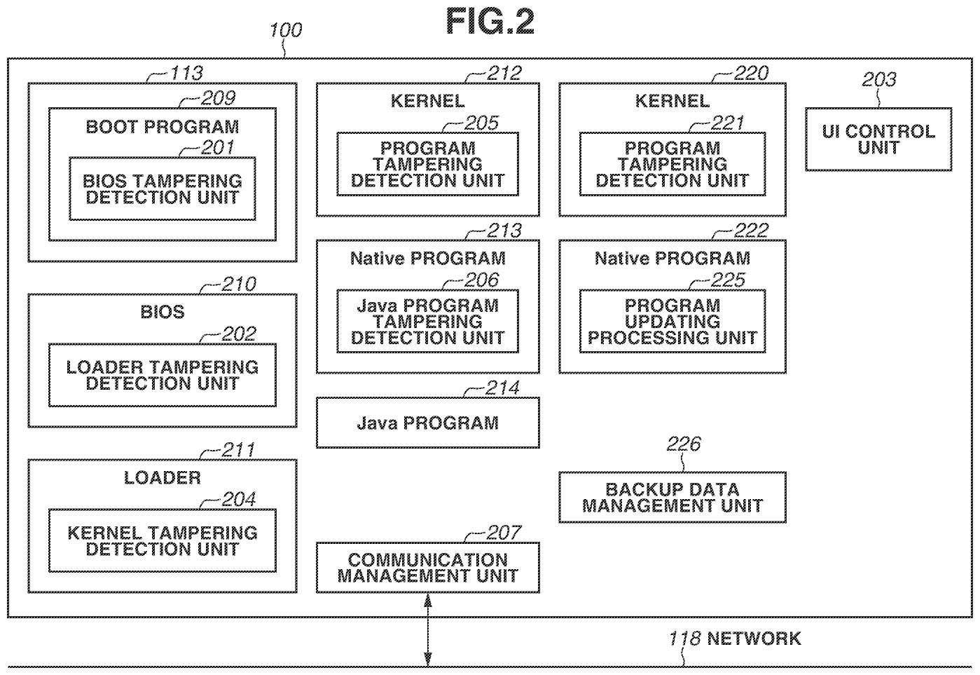

FIG. 2 illustrates an example of a functional configuration of the multifunctional peripheral 100 according to the first exemplary embodiment. The multifunctional peripheral 100 includes a boot program 209 in the embedded controller 113 as a software module. The multifunctional peripheral 100 further includes a BIOS 210, a loader 211, a kernel 212, a native program 213, a Java® program 214, a user interface (UI) control unit 203, and a communication management unit 207 as software modules. The multifunctional peripheral 100 further includes a kernel 220, a native program 222, and a backup data management unit 226 as software modules.

The communication management unit 207 controls the network I/F control unit 105 connected to the network 118 to transmit and receive data to and from outside via the network 118. The UI control unit 203 receives an input operation signal of the operation panel 110 via the panel control unit 108, and performs processing or display on the operation panel 110 based on the input operation.

The boot program 209 is executed by the CPU 115 of the embedded controller 113 when the multifunctional peripheral 100 is powered on. The boot program 209 executes processing related to activation and includes a BIOS tampering detection unit 201 that performs verification for detecting tampering with the BIOS 210.

The BIOS 210 is a program executed by the CPU 101 after an execution of the boot program 209. The BIOS 210 executes processing related to activation, and includes a loader tampering detection unit 202 that performs verification for detecting tampering with the loader 211.

The loader 211 is a program executed by the CPU 101 after a completion of the processing performed by the BIOS 210. The loader 211 executes processing related to activation, and includes a kernel tampering detection unit 204 that performs verification for detecting tampering with the kernel 220.

The kernel 212 is a program executed by the CPU 101 after a completion of the processing performed by the loader 211. The kernel 212 executes processing related to activation, and includes a program tampering detection unit 205 that performs verification for detecting tampering with the native program 213.

The native program 213 is a program executed by the CPU 101, and includes a plurality of programs providing each function in cooperation with the Java program 214 of the multifunctional peripheral 100. Examples of the native program 213 include a program for controlling each of the scanner I/F control unit 106 and the printer I/F control unit 107, and an activation program. The activation program is called from the native program 213 by the kernel 212, so that activation processing is executed. The native program 213 includes a Java program tampering detection unit 206 that performs verification for tampering with the Java program 214, as one of the programs.

The Java program 214 is a program executed by the CPU 101, and provides each function in cooperation with the native program 213 of the multifunctional peripheral 100. For example, the Java program 214 is a program for displaying a screen on the operation panel 110.

The multifunctional peripheral 100 has a plurality of activation modes. The loader 211 switches between the kernels 212 and 220 to be activated, based on a user input provided via the operation panel 110. The kernel 220 is a program executed by the CPU 101 and different from the kernel 212. The kernel 220 executes processing related to activation, and includes a program tampering detection unit 221 that performs verification for detecting tampering with the native program 222.

The native program 222 is a program executed by the CPU 101. The native program 222 includes a program updating processing unit 225, and provides an update function of the multifunctional peripheral 100. The native program 222 is called by the kernel 220, and provides a function of updating the kernel 212, the native program 213, and the Java program 214. The native program 222 may be a program that provides not only the update function but also other functions.

The backup data management unit 226 is called from the kernel 220 or the native program 222 to create backup data of a designated area and store the created data in the HDD 104 or the flash memory 114. The backup data management unit 226 reads backup data stored beforehand and loads the read backup data into a designated area.

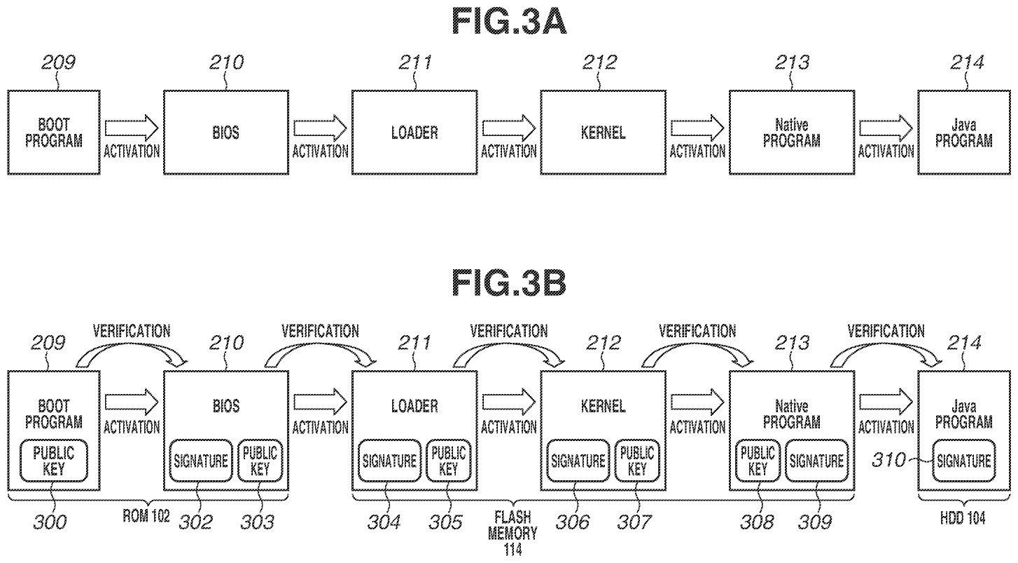

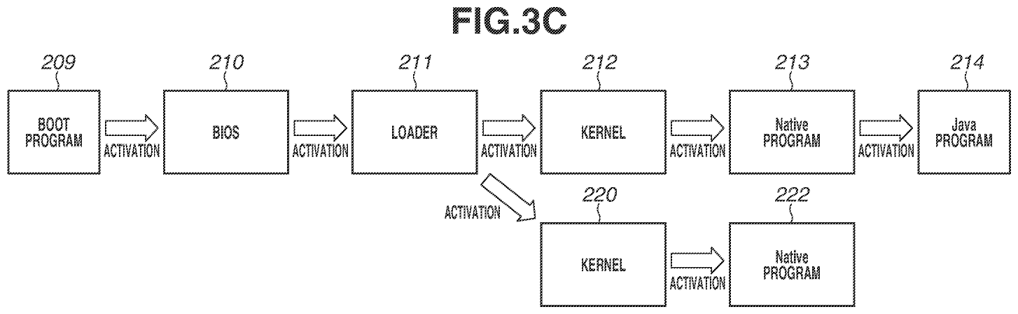

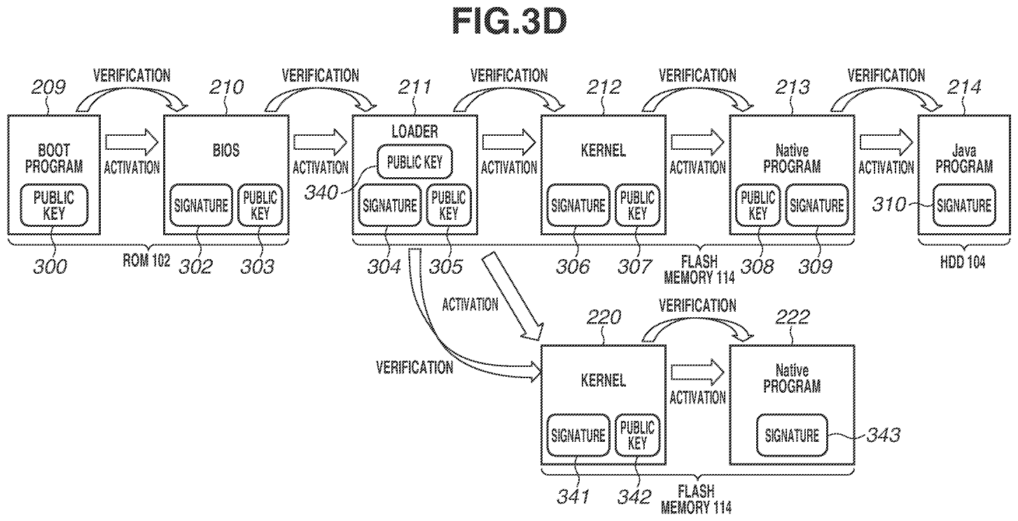

FIGS. 3A to 3D are diagrams illustrating an activation procedure of the multifunctional peripheral 100. FIG. 3A is a diagram illustrating a sequence in which the multifunctional peripheral 100 activates without performing verification for detecting tampering. The boot program 209 activates the BIOS 210, the BIOS 210 activates the loader 211, the loader 211 activates the kernel 212, and the kernel 212 activates the activation program in the native program 213. The activation program activates the Java program 214, and thereafter the native program 213 and the Java program 214 provide a function of the multifunctional peripheral 100 in cooperation with each other. In this way, activation of each of the software modules is controlled in a predetermined sequence, and upon completion of the activation of one software module, the activation processing of the next software module is executed.

FIG. 3B is a diagram illustrating a sequence in which the multifunctional peripheral 100 activates while performing verification for tampering detection. The multifunctional peripheral 100 activates the boot program 209, the BIOS 210, the loader 211, the kernel 212, the native program 213, and the Java program 214 in this order while performing verification for tampering detection. The verification for detecting tampering with a module to be activated is performed by a software module that has been activated immediately before the module. For example, the boot program 209 performs the verification for detecting tampering with the BIOS 210.

FIG. 3B illustrates a storage location for each of the software modules, and a storage location for a digital signature (hereinafter referred to as a signature) and a public key (verification information) for verifying the signature. Each of the software modules includes its own signature. For software modules having the same public key, a predetermined software module has the public key. Since a software module performs the verification for detecting tampering with another software module one after another, there exist a software module holding a public key and a software module not holding a public key. Thus, memory resources can be effectively used.

For example, the boot program 209 and the BIOS 210 are stored in the ROM 102, and the loader 211, the kernel 212, and the native program 213 are stored in the flash memory 114. The Java program 214 is stored in the HDD 104.

The boot program 209 has a public key 300 for signature verification for the BIOS 210. The BIOS 210 has a signature 302 of the BIOS 210 and a public key 303 for signature verification for the loader 211. The loader 211 has a signature 304 of the loader 211 and a public key 305 for signature verification for the kernel 212. The kernel 212 has a signature 306 of the kernel 212 and a public key 307 for signature verification for the native program 213. The native program 213 has a signature 309 of the native program 213 and a public key 308 for signature verification for the Java program 214. The Java program 214 has a signature 310 of the Java program 214. It is preferable to provide the software modules with these public keys and signatures before shipment of the multifunctional peripheral 100 from a factory. The BIOS tampering detection unit 201, the loader tampering detection unit 202, the kernel tampering detection unit 204, the program tampering detection unit 205, and the Java program tampering detection unit 206 each verify the software module to be activated next to each of the units. If there is no tampering with the software module, the next software module is activated.

FIG. 3C is a diagram illustrating an activation procedure in a case where the multifunctional peripheral 100 activates the kernel 220. The boot program 209 activates the BIOS 210, and the BIOS 210 activates the loader 211. The loader 211 activates the kernel 220, and the kernel 220 activates the activation program included in the native program 222. The loader 211 switches between the kernels 212 and 220 to be activated, based on a user input provided via the operation panel 110. The kernel 220 is a program to be executed by the CPU 101 and is different from the kernel 212. The kernel 220 executes the processing related to activation, and includes the program tampering detection unit 221 that performs verification for detecting tampering with the native program 222.

FIG. 3D is a diagram illustrating a processing flow of selecting and activating a target for verification for tampering detection depending on which one of the kernels 212 and 220 is to be activated by the loader 211. The boot program 209 activates the BIOS 210, and the BIOS 210 activates the loader 211. The activation processing performed on the boot program 209, the BIOS 210, and the loader 211 is similar to the activation processing illustrated in FIG. 3B.

The loader 211 has the signature 304 of the loader 211, the public key 305 for signature verification for the kernel 212, and a public key 340 for signature verification for the kernel 220. The kernel 220 has a signature 341 of the kernel 220 and a public key 342 for signature verification for the native program 222. The native program 222 has a signature 343 of the native program 222. It is appropriate to provide the software modules with these public keys and signatures before shipment of the multifunctional peripheral 100 from the factory. As described above, the loader 211 has the public keys (verification information) for the plurality of kernels 212 and 220 that can be activated next.

The loader 211 determines whether the kernel 220 is selected as an activation target via the operation panel 110. If the kernel 220 is selected, the kernel tampering detection unit 204 included in the loader 211 reads, from the flash memory 114, the kernel 220, the public key 342 for signature verification for the native program 222, and the signature 341 of the kernel 220, into the RAM 103. The kernel tampering detection unit 204 performs verification of the signature 341 of the kernel 220 using the public key 342 for signature verification for the kernel 220, and determines whether the verification is successful. In a case where the verification of the signature is successful, the kernel tampering detection unit 204 terminates the processing, and the loader 211 activates the kernel 220 read into the RAM 103.

The kernel 220 performs various initialization processes when activated. The program tampering detection unit 221 included in the kernel 220 reads, from the flash memory 114, the native program 222 and the signature 343 of the native program 222, into the RAM 103. The program tampering detection unit 221 performs verification of the signature 343 of the native program 222 using the public key 342 for signature verification for the native program 222, and determines whether the verification is successful. In a case where the verification of the signature is successful, the program tampering detection unit 221 terminates the processing, and the kernel 220 activates the native program 222. When activated, the native program 222 provides the update function to the user.

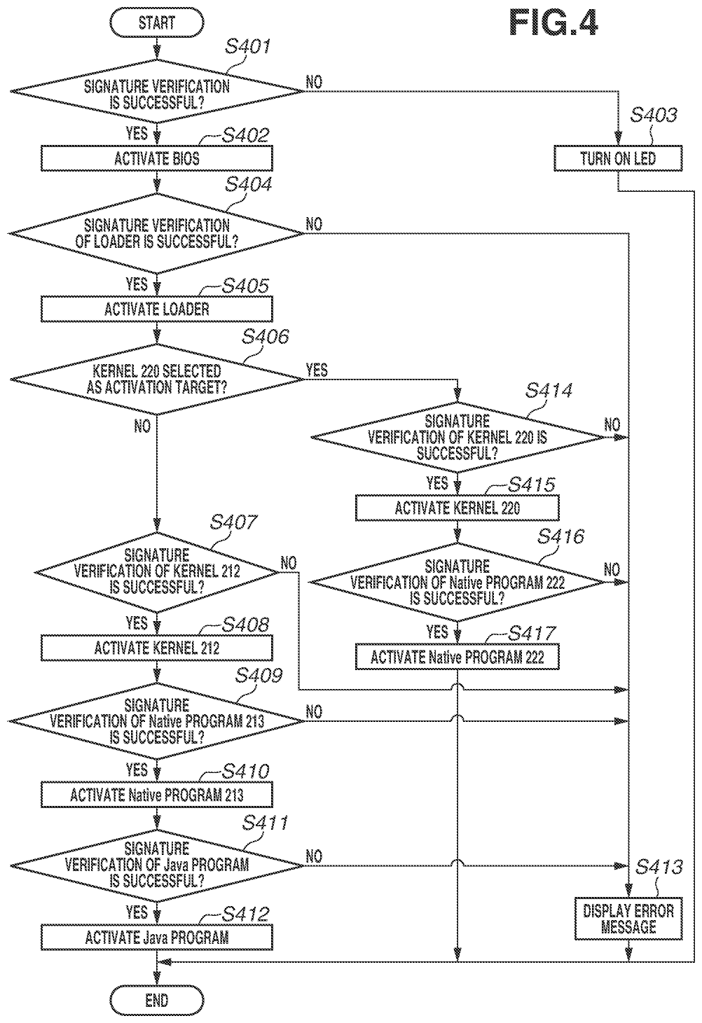

FIG. 4 is a flowchart illustrating a processing method in activating the multifunctional peripheral 100, and indicating a procedure of verification for tampering detection. When the multifunctional peripheral 100 is powered on, the boot program 209 is read from the ROM 102 into the RAM 116, and the CPU 115 activates the boot program 209.

In step S401, the BIOS tampering detection unit 201 included in the boot program 209 serves as a verification unit, performs verification of the signature 302 of the BIOS 210, and determines whether the verification is successful. Specifically, the BIOS tampering detection unit 201 reads, from the flash memory 114, the BIOS 210, the public key 303 for signature verification for the loader 211, and the signature 302 of the BIOS 210, into the RAM 116. The BIOS tampering detection unit 201 performs verification of the signature 302 of the BIOS 210 using the public key 300 for signature verification for the BIOS 210, and determines whether the verification is successful. If the verification of the signature 302 is unsuccessful (NO in step S401), the BIOS tampering detection unit 201 determines that the BIOS 210 is tampered with, and the processing proceeds to step S403. If the verification of the signature 302 is successful (YES in step S401), the BIOS tampering detection unit 201 determines that the BIOS 210 is not tempered with, turns on the CPU 101, and terminates the processing of the boot program 209. The processing then proceeds to step S402 to be executed by the CPU 101.

In step S403, the BIOS tampering detection unit 201 turns on the LED 117, and terminates the processing illustrated in FIG. 4.

In step S402, the CPU 101 serves as an activation unit. The CPU 101 reads, from the flash memory 114, the BIOS 210 and the public key 303 for signature verification for the loader 211, into the RAM 103, and activates the BIOS 210. The processing then proceeds to step S404. The CPU 101 performs the subsequent steps.

In step S404, the CPU 101 uses the BIOS 210 to perform various initialization processes. The loader tampering detection unit 202 included in the BIOS 210 reads, from the flash memory 114, the loader 211, the public key 305 for signature verification for the kernel 212, and the signature 304 of the loader 211, into the RAM 103. The loader tampering detection unit 202 serves as a verification unit, performs verification of the signature 304 of the loader 211 using the public key 305 for signature verification for the loader 211, and determines whether the verification is successful. If the verification of the signature 304 is unsuccessful (NO in step S404), the loader tampering detection unit 202 determines that the loader 211 is tampered with, and the processing proceeds to step S413. If the verification of the signature 304 is successful (YES in step S404), the loader tampering detection unit 202 determines that the loader 211 is not tampered with, and the processing proceeds to step S405.

In step S413, the loader tampering detection unit 202 serves as a display control unit, and displays an error message on the operation panel 110, and ends the processing illustrated in FIG. 4.

In step S405, the CPU 101 serves as an activation unit, and activates the loader 211 read into the RAM 103 using the BIOS 210. The processing then proceeds to step S406.

In step S406, the CPU 101 uses the loader 211 to determine whether the kernel 220 is selected as an activation target via the operation panel 110. If the kernel 220 is not selected as the activation target (NO in step S406), the processing proceeds to step S407. If the kernel 220 is selected as the activation target (YES in step S406), the processing proceeds to step S414.

The switching between the kernels 212 and 220 is not limited to the selection by the user operation. The switching between the kernels 212 and 220 may depend on a flag held in the multifunctional peripheral 100 or the presence/absence of an error occurring in the multifunctional peripheral 100. If the normal activation is to be performed, the processing proceeds to step S407. If the kernel 220 is to be activated, the processing proceeds to step S414.

In step S407, the CPU 101 uses the loader 211 to perform various initialization processes. The kernel tampering detection unit 204 included in the loader 211 reads, from the flash memory 114, the kernel 212, the public key 307 for signature verification for the native program 213, and the signature 306 of the kernel 212, into the RAM 103. The kernel tampering detection unit 204 serves as a verification unit. The kernel tampering detection unit 204 performs verification of the signature 306 of the kernel 212 using the public key 305 for signature verification for the kernel 212, and determines whether the verification is successful. If the verification of the signature 306 is unsuccessful (NO in step S407), the kernel tampering detection unit 204 determines that the kernel 212 is tampered with, and the processing proceeds to step S413. In step S413, the kernel tampering detection unit 204 displays an error message on the operation panel 110, and ends the processing illustrated in FIG. 4. If the verification of the signature 306 is successful (YES in step S407), the kernel tampering detection unit 204 determines that the kernel 212 is not tampered with, and the processing proceeds to step S408.

In step S408, the CPU 101 serves as an activation unit. The CPU 101 uses the loader 211 to activate the kernel 212 read into the RAM 103, and the processing proceeds to step S409.

In step S409, the CPU 101 uses the kernel 212 to perform various initialization processes. The program tampering detection unit 205 included in the kernel 212 reads, from the flash memory 114, the native program 213, the public key 308 for signature verification for the Java program 214, and the signature 309 of the native program 213, into the RAM 103. The program tampering detection unit 205 serves as a verification unit. The program tampering detection unit 205 performs verification of the signature 309 of the native program 213 using the public key 307 for signature verification for the native program 213, and determines whether the verification is successful. If the verification of the signature 309 is unsuccessful (NO in step S409), the program tampering detection unit 205 determines that the native program 213 is tampered with, and the processing proceeds to step S413. In step S413, the program tampering detection unit 205 displays an error message on the operation panel 110, and ends the processing illustrated in FIG. 4. If the verification of the signature 309 is successful (YES in step S409), the program tampering detection unit 205 determines that the native program 213 is not tampered with, and the processing proceeds to step S410.

In step S410, the CPU 101 serves as an activation unit. The CPU 101 uses the kernel 212 to activate the native program 213, and the processing proceeds to step S411.

In step S411, the Java program tampering detection unit 206 included in the native program 213 reads, from the HDD 104, the Java program 214 and the signature 310 of the Java program 214, into the RAM 103. The Java program tampering detection unit 206 serves as a verification unit. The Java program tampering detection unit 206 performs verification of the signature 310 of the Java program 214 using the public key 308 for signature verification for the Java program 214, and determines whether the verification is successful. If the verification of the signature 310 is unsuccessful (NO in step S411), the Java program tampering detection unit 206 determines that the Java program 214 is tampered with, and the processing proceeds to step S413. In step S413, the Java program tampering detection unit 206 displays an error message on the operation panel 110, and ends the processing illustrated in FIG. 4. If the verification of the signature 310 is successful (YES in step S411), the Java program tampering detection unit 206 determines that the Java program 214 is not tampered with, and the processing proceeds to step S412.

In step S412, the CPU 101 serves as an activation unit. The CPU 101 uses the native program 213 to activate the Java program 214, and ends the processing illustrated in FIG. 4.

In step S414, the CPU 101 uses the loader 211 to perform various initialization processes. The kernel tampering detection unit 204 included in the loader 211 reads, from the flash memory 114, the kernel 220, the public key 342 for signature verification for the native program 222, and the signature 341 of the kernel 220, into the RAM 103. The kernel tampering detection unit 204 serves as a verification unit. The kernel tampering detection unit 204 performs verification of the signature 341 of the kernel 220 using the public key 340 for signature verification for the kernel 220, and determines whether the verification is successful. If the verification of the signature 341 is unsuccessful (NO in step S414), the kernel tampering detection unit 204 determines that the kernel 220 is tampered with, and the processing proceeds to step S413. In step S413, the kernel tampering detection unit 204 displays an error message on the operation panel 110, and ends the processing illustrated in FIG. 4. If the verification of the signature 341 is successful (YES in step S414), the kernel tampering detection unit 204 determines that the kernel 220 is not tampered with, and the processing proceeds to step S415.

In step S415, the CPU 101 serves as an activation unit. The CPU 101 uses the loader 211 to activate the kernel 220 read into the RAM 103, and the processing proceeds to step S416.

In step S416, the CPU 101 uses the kernel 220 to perform various initialization processes. The program tampering detection unit 221 included in the kernel 220 reads, from the flash memory 114, the native program 222 and the signature 343 of the native program 222, into the RAM 103. The program tampering detection unit 221 serves as a verification unit. The program tampering detection unit 221 performs verification of the signature 343 of the native program 222 using the public key 342 for signature verification for the native program 222, and determines whether the verification is successful. If the verification of the signature 343 is unsuccessful (NO in step S416), the program tampering detection unit 221 determines that the native program 222 is tampered with, and the processing proceeds to step S413. In step S413, the program tampering detection unit 221 displays an error message on the operation panel 110, and ends the processing illustrated in FIG. 4. If the verification of the signature 343 is successful (YES in step S416), the program tampering detection unit 221 determines that the native program 222 is not tampered with, and the processing proceeds to step S417.

In step S417, the CPU 101 serves as an activation unit. The CPU 101 executes the kernel 220 to activate the native program 222, and ends the processing illustrated in FIG. 4.

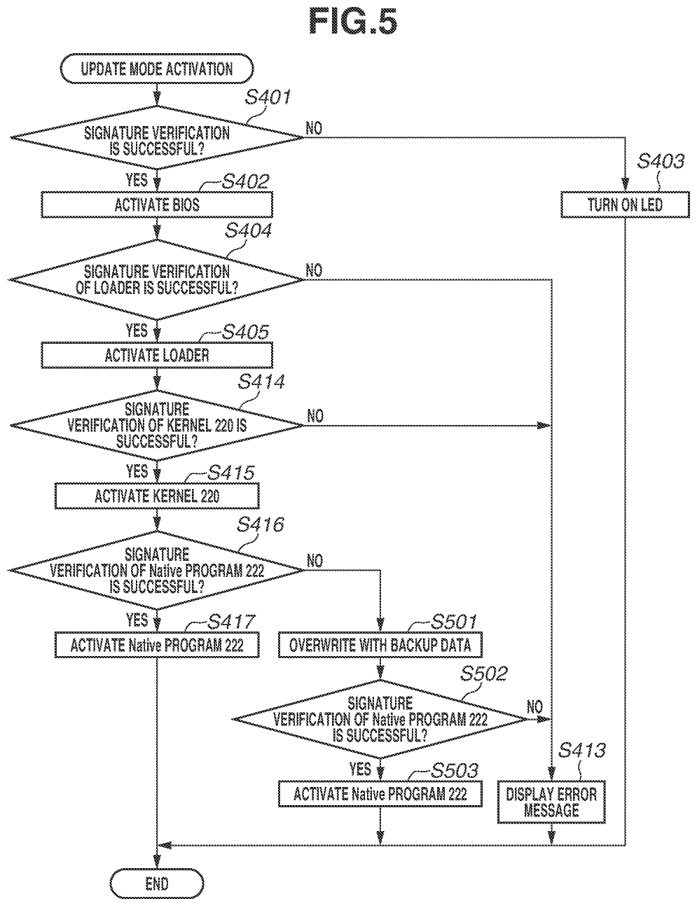

FIG. 5 is a flowchart illustrating a restoration processing procedure in activating the multifunctional peripheral 100. Steps S401 to S405 and steps S413 to S417 are similar to those illustrated in FIG. 4 and thus will not be described.

In step S416, the CPU 101 uses the kernel 220 to perform various initialization processes. The program tampering detection unit 221 included in the kernel 220 reads, from the flash memory 114, the native program 222 and the signature 343 of the native program 222, into the RAM 103. The program tampering detection unit 221 performs verification of the signature 343 of the native program 222 using the public key 342 for signature verification for the native program 222, and determines whether the verification is successful. If the verification of the signature 343 is successful (YES in step S416), the processing proceeds to step S417. In step S417, the CPU 101 uses the kernel 220 to activate the native program 222. When activated, the native program 222 provides the update function to the user. If the verification of the signature 343 is unsuccessful (NO in in step S416), the program tampering detection unit 221 determines that the native program 222 is tampered with, and the processing proceeds to step S501.

In step S501, to restore the native program 222 for which the verification is unsuccessful, the CPU 101 uses the kernel 220 to update the native program 222 using the backup data management unit 226. The backup data management unit 226 reads backup data of the native program 222 from a specific area of the HDD 104 or the flash memory 114. The backup data management unit 226 serves as an updating unit. The backup data management unit 226 updates the native program 222 by overwriting the native program 222 stored in the flash memory 114 with the backup data of the native program 222. The processing then proceeds to step S502.

The backup data of the native program 222 is written in the HDD 104 or the flash memory 114 when the multifunctional peripheral 100 is manufactured. The backup data is stored in an area where overwriting by processing, such as updating, is prohibited.

In step S502, the CPU 101 uses the kernel 220 to perform verification for tampering with the updated native program 222. Specifically, the program tampering detection unit 221 included in the kernel 220 reads, from the flash memory 114, the updated native program 222 and the signature 343 of the updated native program 222, into the RAM 103. The program tampering detection unit 221 serves as a verification unit. The program tampering detection unit 221 performs verification of the signature 343 of the updated native program 222 using the public key 342 for signature verification for the native program 222, and determines whether the verification is successful. If the verification of the signature 343 is unsuccessful (NO in step S502), the program tampering detection unit 221 determines that the updated native program 222 is tampered with, and the processing proceeds to step S413. In step S413, the program tampering detection unit 221 displays an error message on the operation panel 110, and ends the processing illustrated in FIG. 5. If the verification of the signature 343 is successful (YES in step S502), the program tampering detection unit 221 determines that the updated native program 222 is not tampered with, and the processing proceeds to step S503.

In step S503, the CPU 101 serves as an activation unit. The CPU 101 uses the kernel 220 to activate the updated native program 222, and ends the processing illustrated in FIG. 5. The native program 222 has the update function. The native program 222 can be restored with the backup data using this function, even in a case where the native program 222 is determined to be tampered with.

As described above, the multifunctional peripheral 100 can execute restoration by writing back the backup data even in a case where the native program 222 is determined to be tampered with in a plurality of activation modes.

The multifunctional peripheral 100 according to a second exemplary embodiment will now be described. In the first exemplary embodiment, the backup data of the native program 222 is written when the multifunctional peripheral 100 is manufactured. The software module of the multifunctional peripheral 100 is updated every day, and therefore, the backup data created at the time of manufacturing is unlikely to have a function sufficient for restoration. In the second exemplary embodiment, the multifunctional peripheral 100 therefore updates the latest native program 222 as appropriate.

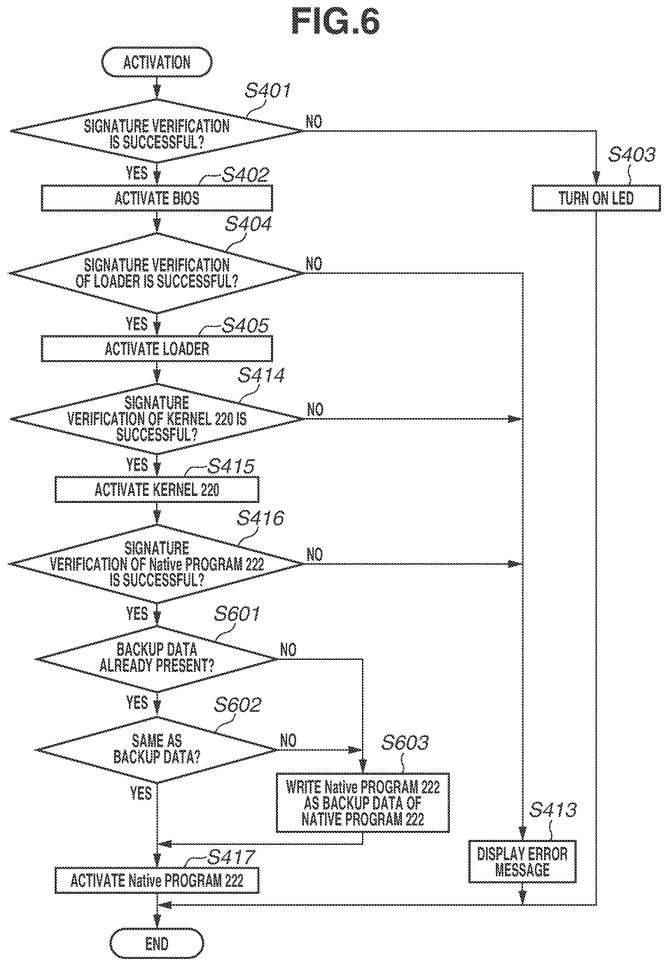

FIG. 6 is a flowchart illustrating a updating processing procedure for the native program 222 in activating the multifunctional peripheral 100 according to the second exemplary embodiment. Steps S401 to S417 are similar to those illustrated in FIG. 4 and thus will not be described.

In step S416, the program tampering detection unit 221 determines whether the verification of the signature 343 of the native program 222 is successful. If the verification is successful (YES in step S416), the program tampering detection unit 221 determines that the native program 222 is not tampered with, and the processing proceeds to step S601.

In step S601, the CPU 101 uses the kernel 220 to determine whether the backup data of the native program 222 is already present, using the backup data management unit 226. If the backup data of the native program 222 is already present (YES in step S601), the processing proceeds to step S602. If the backup data of the native program 222 is not present (NO in step S601), the processing proceeds to step S603.

In step S602, the backup data management unit 226 determines whether the native program 222 is the same as the backup data of the native program 222. Specifically, the backup data management unit 226 determines whether the version number of the native program 222 is the same as the version number of the backup data of the native program 222. If the version numbers are the same (YES in step S602), the backup data management unit 226 determines that the native program 222 is the same as the backup data of the native program 222, and the processing proceeds to step S417. If the version numbers are different (NO in step S602), the backup data management unit 226 determines that the native program 222 is different from the backup data of the native program 222, and the processing proceeds to step S603.

In step S603, the backup data management unit 226 reads the native program 222 from the flash memory 114. Subsequently, the backup data management unit 226 serves as a write unit, and writes the native program 222 into the HDD 104 or the flash memory 114 as the backup data of the native program 222. The processing then proceeds to step S417. In this process, the backup data management unit 226 may compress the backup data of the native program 222.

In step S417, the CPU 101 serves as an activation unit. The CPU 101 uses the kernel 220 to activate the native program 222, and ends the processing illustrated in FIG. 6.

As described above, the multifunctional peripheral 100 according to the second exemplary embodiment can produce an effect equivalent to that of the first exemplary embodiment, while appropriately updating the backup data.

The multifunctional peripheral 100 is not limited to the first and second exemplary embodiments and can be variously modified. In the first and second exemplary embodiments, the public keys are described to be different, but may be identical. The storage location of each of the software modules is described to be any of the ROM 102, the flash memory 114, and the HDD 104, but may be any other storage medium. The storage location of each of the software modules may be a location different from the described location. For example, a configuration in which the loader 211 is stored in the ROM 102 may be adopted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-006858, filed Jan. 20, 2020, which is hereby incorporated by reference herein in its entirety.

What is claimed is:

1. An information processing apparatus comprising:
at least one memory, the at least one memory storing one or more programs;
a processor configured to execute a program in a first activation mode, and execute an update program for updating at least a part of the program executed in the first activation mode in a second activation mode;
a storage configured to store backup data of the update program; and
a tampering detection program stored in the at least one memory and configured to detect tampering with the update program,
wherein the update program for which tampering is detected by the tampering detection program is updated using the backup data stored in the storage.

2. The information processing apparatus according to claim 1, wherein the processor updates the update program for which tampering is detected by the tampering detection program, using the backup data stored in the storage.

3. The information processing apparatus according to claim 1, wherein the update program is updated by overwriting the update program with the backup data.

4. The information processing apparatus according to claim 1, wherein the tampering detection program detects tampering with the updated update program.

5. The information processing apparatus according to claim 1, further comprising a display configured to display an error in a case where tampering with the updated update program is detected by the tampering detection program.

6. The information processing apparatus according to claim 1, wherein the update program does not update an area in which the backup data is stored.

7. The information processing apparatus according to claim 1, wherein the storage storing the backup data is different from a storage storing the update program.

8. The information processing apparatus according to claim 1, wherein the processor executes the update program for which tampering is not detected by the tampering detection program.

9. The information processing apparatus according to claim 1, wherein the update program is updated.

10. The information processing apparatus according to claim 1, further comprising a printing unit configured to print an image on a sheet.

11. The information processing apparatus according to claim 1, further comprising a reading unit configured to read an image of a document.

12. A method of updating an update program, the method comprising:
executing a program in a first activation mode;
executing an update program for updating at least a part of the program executed in the first activation mode in a second activation mode;
storing backup data of the update program;
detecting tampering with the update program; and
updating the update program for which tampering is detected in the detecting, using the backup data stored in the storage.
